(19) United States
(12) Patent Application Publication
(10) Pub. No.: US 2012/0007749 A1
(43) Pub. Date: Jan. 12, 2012

(54) System for Identifying Vehicles in a Parking Facility

(75) Inventors: Joseph R. Oldknow, Marietta, GA (US); Barry E. Martin, Suwanee, GA (US)

(73) Assignee: STALLION SYSTEMS, INC., Atlanta, GA (US)

(21) Appl. No.: 13/178,255

(22) Filed: Jul. 7, 2011

Related U.S. Application Data
(60) Provisional application No. 61/362,057, filed on Jul. 7, 2010.

(51) Int. Cl. G08G 1/01

(52) U.S. Cl. 340/933

(57) ABSTRACT

A sensor system for detecting a vehicle on a driving surface includes a sealed casing, an integrated circuit vehicle detector, an integrated circuit transmitter and controller, and a battery. The sealed casing has a top surface and defines a cavity therein. The integrated circuit vehicle detector is disposed within the cavity and is configured to generate a vehicle present electrical signal when the vehicle is within a predetermined distance from the sensor system. The integrated circuit transmitter and controller is disposed within the cavity and is in communication with the integrated circuit vehicle detector. The integrated circuit transmitter and controller is configured to generate a vehicle present radio frequency signal in response to the vehicle present electrical signal. The battery is disposed within the cavity and is electrically coupled to the integrated circuit vehicle detector and the integrated circuit transmitter and controller.

### CROSS-REFERENCE TO RELATED APPLICATION(S)

This application claims the benefit of U.S. Provisional Patent Application Ser. No. 61/362,057, filed Jul. 7, 2010, the entirety of which is hereby incorporated herein by reference.

### BACKGROUND OF THE INVENTION

1. Field of the Invention

The present invention relates to vehicle sensing systems and, more specifically, to a vehicle sensing system employing wireless technology.

2. Description of the Related Art

Parking facilities, such as parking garages, often use automatic gate systems to control access to their parking facilities. Such automatic gate systems often use induction loops implanted in the pavement next to a gate to sense the presence of a vehicle. When a vehicle passes over an induction loop, a signal is sent to a gate control unit, causing it to take certain actions. For example, if the vehicle passes over an induction loop at an exit gate, the driver may be instructed to insert a parking ticket into a reader machine that determines the amount of time the vehicle parked in the facility and the amount due. Once payment is received, the control unit will cause the gate to be lifted to allow the vehicle to exit the facility.

An induction loop is typically made of a simple 14 gauge wire that is embedded in a rectangular groove cut in the pavement and that is connected to a loop detecting circuit in a housing associated with the gate. The wire is often wrapped three times around the groove and then continues via a linear groove cut in the pavement to the housing. Each gate usually uses two induction loops: a first to detect when a vehicle approaches a gate and a second to detect when the vehicle has passed through the gate.

An induction loop relies on the fact that moving magnets induce electrical current as they pass near conductors. Given that a typical motor vehicle includes significant amounts of iron and steel, it will create a fluctuation in the local ambient magnetic field as it passes by an induction loop. This fluctuation induces a current in the wire of the induction loop, which is detected by the loop detecting circuit.

An induction loop is usually installed by cutting the grooves in the pavement with a concrete saw. The wire is placed in the groove and a silicone filler is placed in the groove to seal the groove so as to protect the wire from the environment.

The cost to install or replace an induction loop is usually more than $250. Depending upon the physical and environmental conditions at the facility, the induction loop will have a life span of around four years. The physical factors that affect the life expectancy of the loop are condition of the asphalt and concrete that the loop is originally placed in. Environmental factors that affect the life expectancy of the loops are heat, cold, moisture, and humidity which cause movement in the concrete or asphalt.

The presence of induction loops can detract from the appearance of a parking facility and the cost to install and repair induction loops can be substantial—especially in multi-lane facilities. Also, in some climates moisture can seep into the groove and can harm the surrounding pavement through heat and thaw cycles.

Therefore, there is a need for a vehicle sensor unit that does not require an induction loop.

### SUMMARY OF THE INVENTION

The disadvantages of the prior art are overcome by the present invention which, in one aspect, is a sensor system for detecting a vehicle on a driving surface that includes a sealed casing, an integrated circuit vehicle detector, an integrated circuit transmitter and controller, and a battery. The sealed casing has a top surface and defines a cavity therein. The integrated circuit vehicle detector is disposed within the cavity and is configured to generate a vehicle present electrical signal when the vehicle is within a predetermined distance from the sensor system. The integrated circuit transmitter and controller is disposed within the cavity and is in communication with the integrated circuit vehicle detector. The integrated circuit transmitter and controller is configured to generate a vehicle present radio frequency signal in response to the vehicle present electrical signal. The battery is disposed within the cavity and is electrically coupled to the integrated circuit vehicle detector and the integrated circuit transmitter and controller.

In another aspect, the invention is a vehicle sensor system for detecting a vehicle on a driving surface. The system includes a sealed casing having a top surface and defining a cavity therein. The sealed casing includes a vulcanized rubber cylinder having a circular vulcanized rubber bottom floor sealed about a periphery to an interior portion of the rubber cylinder and a vulcanized rubber top cover sealed to a top edge of the rubber cylinder. An integrated circuit vehicle detector is disposed within the cavity and is configured to generate a vehicle present electrical signal when the vehicle is within a predetermined distance from the sensor system. An integrated circuit transmitter and controller is disposed within the cavity and is in communication with the integrated circuit vehicle detector. The integrated circuit transmitter and controller is configured to generate a vehicle present radio frequency signal in response to the vehicle present electrical signal. A battery is disposed within the cavity and is electrically coupled to the integrated circuit vehicle detector and the integrated circuit transmitter and controller. A magnetically sensitive reed switch is disposed adjacent a top portion of the sealed casing inside the cavity and is configured to couple selectively the battery to the integrated circuit vehicle detector and the integrated circuit transmitter and controller. The reed switch is responsive to a magnet so that the reed switch is held open and the sensor is maintained in an inactive state when the magnet is disposed on the top surface of the sealed casing and so that the reed switch is closed and the sensor system is activated when the magnet is removed from the top surface of the casing.

In yet another aspect, the invention is a parking garage gate system that includes a sensor system, a vehicle passage control gate and a gate control unit. The sensor system is configured to detect a vehicle on a driving surface and includes a sealed casing, an integrated circuit vehicle detector, an integrated circuit transmitter and controller and a battery. The sealed casing has a top surface and defines a cavity therein. The integrated circuit vehicle detector is disposed within the cavity and is configured to generate a vehicle present electrical signal when the vehicle is within a predetermined distance from the sensor system. The integrated circuit transmitter and controller is disposed within the cavity and is in communication with the integrated circuit vehicle detector. The integrated circuit transmitter and controller is configured to generate a vehicle present radio frequency signal in response to the vehicle present electrical signal. The battery is disposed within the cavity and is electrically coupled to the integrated circuit vehicle detector and the integrated circuit transmitter and controller. The gate control unit includes a wireless receiver that is responsive to the vehicle present radio frequency signal and is configured to cause the vehicle passage control gate to enter a preselected state in response to the vehicle present radio frequency signal.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic diagram of a first embodiment of a sensing system.

FIGS. 2A-2C are schematic diagrams of a second embodiment of a sensing system.

FIG. 3 is a perspective view of a sensing system as shown in FIG. 2A.

FIG. 4 is a schematic diagram of a second embodiment of a sensing system.

FIG. 5 is a schematic diagram of a third embodiment of a sensing system.

FIG. 6 is a schematic diagram of a fourth embodiment of a sensing system.

FIG. 7 is a schematic diagram of a fifth embodiment of a sensing system.

FIG. 8 is a schematic diagram of a sixth embodiment of a sensing system.

FIG. 9 is a schematic diagram of a seventh embodiment of a sensing system.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

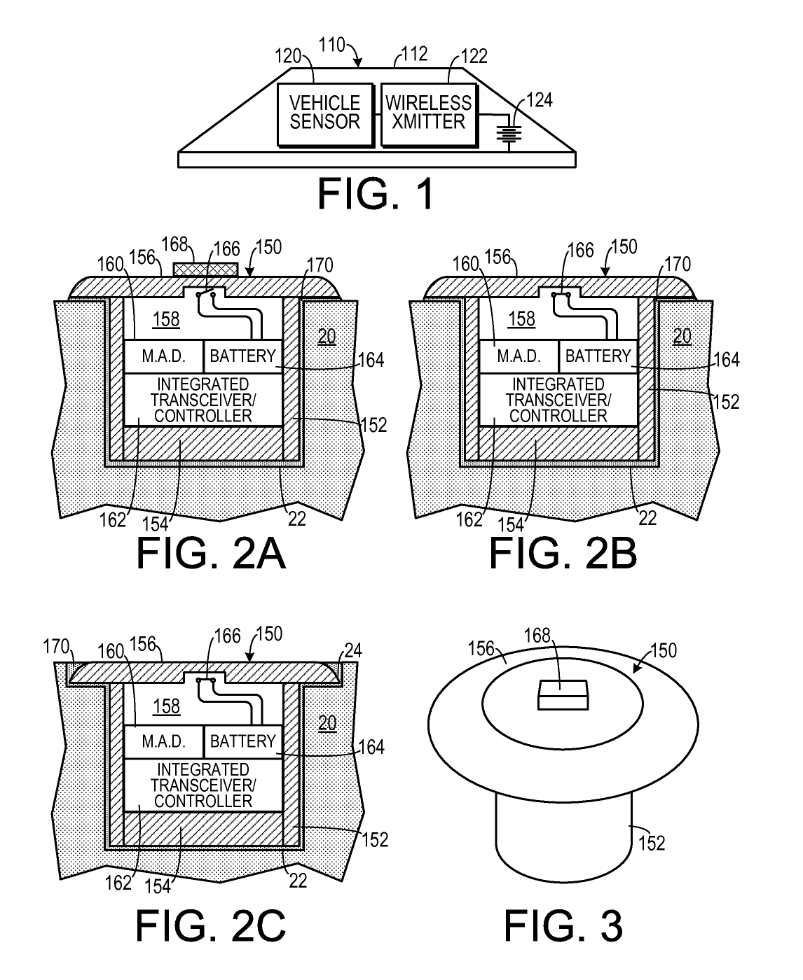

As shown in FIG. 1, one embodiment is a vehicle sensor device 110 disposed in a road reflector body 112. The vehicle sensor device 110 includes a vehicle sensor 120 (which could be, e.g., an RFID sensor, a magnetic switch, an induction coil, or one of any of the non-contact vehicle sensors known to the art) that is in communication with a wireless transmitter 122. The vehicle sensor 120 detects the presence or the absence of a vehicle and the wireless transmitter 122 transmits information from the vehicle sensor 120 to a receiver in a useful data format (such as TCP-IP). The vehicle sensor device 110 is powered by a power source, such as a battery 124.

In another embodiment of a vehicle sensor system, as shown in FIGS. 2A-2C, includes a casing 150 that includes a vulcanized rubber cylinder 152 having a vulcanized rubber bottom 154 sealed thereto and a vulcanized rubber top 156 also sealed thereto. The casing 150 defines a cavity 158. An integrated circuit magnetic anomaly detector unit 160 (such as an Xtrinsic MAG3110 Magnetometer, available from Freescale Semiconductor, Inc., Austin, Tex.) is disposed within the cavity 158. An integrated circuit combination microcontroller (or microprocessor) and radiofrequency transceiver unit 162 (such as a PiP MC13224V, also available from Freescale Semiconductor) is in communication with the magnetic anomaly detector unit 160 and is also disposed within the cavity 158. These two units are powered by a batter 164 (such as a 3.6V lithium ion battery rated at 19.5 amp-hours), which is also disposed within the cavity 158.

In one embodiment, the vulcanized rubber cylinder 152 is 1½″ in diameter and 3″ tall. The vulcanized rubber bottom 154 and the vulcanized rubber top 156 are sealed to the cylinder 152 with an adhesive that makes the unit watertight. (One example of an adhesive that is suitable for certain embodiments is BONDiT B-45 available from Reltek LLC, Santa Rosa, Calif.)

The magnet anomaly detector 160 generates and electrical signal when a large ferrous body, such as a vehicle, passes nearby. The transceiver and controller unit 162 is programmed to generate a radio frequency signal indicating the presence of a vehicle upon receipt of the electrical signal from the magnet anomaly detector 160. The radio frequency signal is received by a receiver and is used by a controller coupled to the receiver to take a predefined action (such as opening or closing a gate).

A magnetic reed switch 166 is coupled to the battery 164 so that power is not supplied to the microcontroller-transceiver unit 162 when the reed switch 166 is held in the open state. Power is supplied to the to the microcontroller-transceiver unit 162 when the reed switch 166 is closed. A magnet 168 disposed on the top 156 maintains the reed switch 166 in the open state before the sensor system is activated for use. To activate the sensor system, the magnet 168 is removed (as shown in FIG. 2B), thereby closing the reed switch 166 and supplying power to the other units within the cavity 158. The magnet 168 can be held to the top 156 prior to activation with tape or a non-permanent adhesive. Keeping the unit deactivated prior to use maintains battery life and prevents unwanted sending of radio signals thereby allowing the sensor system to be shipped by air freight.

In use, this embodiment of the sensor system is placed in a hole 22 cut into the pavement 20 that is complimentary in shape to the rubber cylinder 152. A silicone-based adhesive/sealant 170 seals the sensor system into the hole 22 and to the pavement 20. When used in environments subject to snow plows, a top cut 24 expands the hole 22 to accommodate the top 156 of the sensor system so that the top 156 is flush with the surface of the pavement 20. A perspective view of this embodiment is shown in FIG. 3.

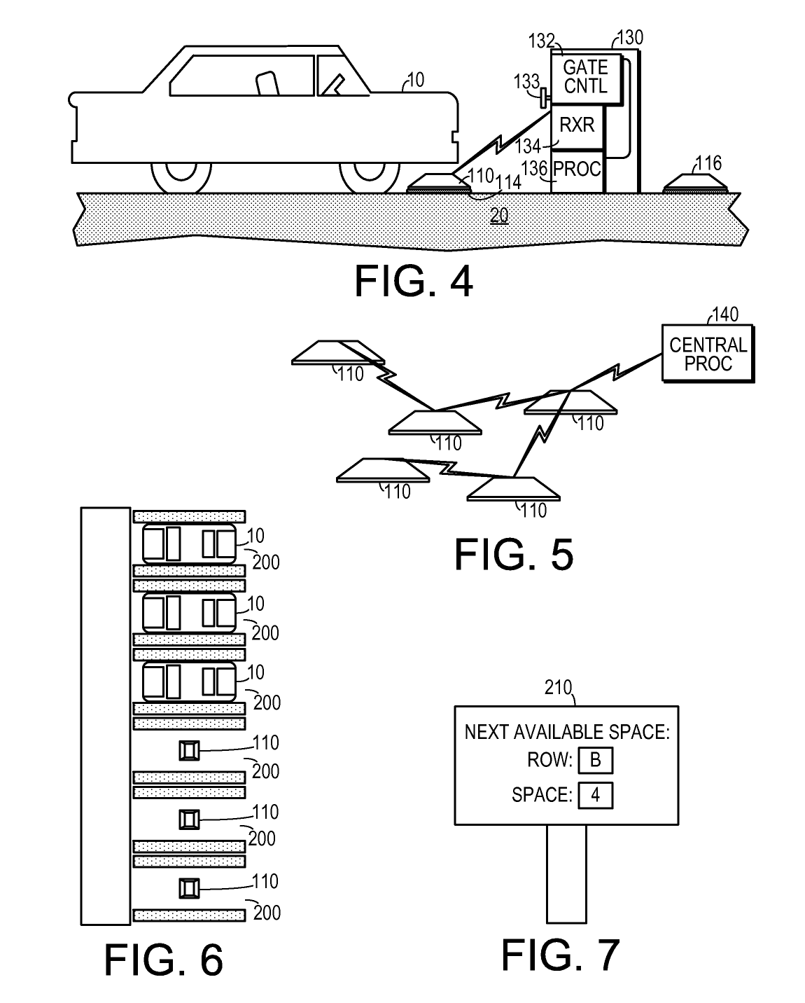

In one embodiment configured for parking lots, as shown in FIG. 4, the vehicle sensor device 110 is affixed onto a surface of a pavement 20 with an adhesive 114. In one embodiment, the sensor device 110 could be configured to communicate with an RFID tag (not shown) affixed to a vehicle 10 to identify the vehicle 10 uniquely. When a vehicle 10 is detected (either through magnetic anomaly detection, in one embodiment, or through RFID detection in another embodiment), the vehicle sensor device 110 communicates with a gate unit 130. The gate unit includes a receiver 134 coupled to a processor 136, which is coupled to a gate controller 132 that actuates the rising and lowering of a vehicle passage control gate 133. The processor 136 could be located at the gate or it could be a central processor coupled to several different gates. The vehicle passage control gate 133 can be a typical retractable gate or any device used to control passage of a vehicle. For example, it could include hydraulically-activated metal cylinders that are raised or lowered from holes in the pavement. It could also include a controllable tire-ripper device. These are just two examples of the many devices known to be used to control passage of vehicles and that could be used with the present invention. A second vehicle sensor device 116 is used to sense when the vehicle 10 has passed through the gate 133.

When a vehicle reaches the first sensor device 110, the first sensor device 110 sends a radio frequency signal to the receiver 134. The receiver 134 generates a signal that alerts the processor 136 to the presence of the vehicle. If the vehicle 10 is entering the parking facility, the processor 136 can require the vehicle 10 to take a ticket or it can record an identification of the vehicle. When the vehicle 10 is exiting the parking facility, the processor 136 can request payment from the driver of the vehicle 10 and raise the gate upon receipt. The processor 136 may be configured to use identification of the vehicle 10 (e.g., with an RFID tag reader or a bar code reader) and calculate the difference between the time that the vehicle entered the parking lot and the time the vehicle 10 exited the parking lot for the purpose of charging the owner of the vehicle for parking at the parking lot. Once the vehicle 10 has passed through the gate 133 the second vehicle sensor 116 senses the passing by of the vehicle 10 and sends a second radio frequency signal to the receiver 134. The processor 136 then instructs the gate controller 132 to close the gate 133.

In one embodiment, as shown in FIG. 5, several different vehicle sensor devices 110 may be distributed spatially. The vehicle sensor devices 110 may communicate with each other and a central processor 104 via a mesh network (such as a Zigbee network). As shown in FIG. 6, this embodiment may be employed in a parking lot, where a different vehicle sensor device 110 is applied to each parking space 200. In this embodiment, the system can detect whether each space is occupied by a vehicle 10 or is empty. This embodiment can use sensor units 110 connected in a mesh network that communicates throughout a parking garage. The mesh network would overcome the isolation of different sensor devices 110 resulting from the concrete and steel floor structures of the parking garage. In such an embodiment, each sensor device 110 would include a unique identifier stored in a non-volatile memory that would identify the sensor unit 110 to the processor. The processor would be programmed to map each sensor unit 110 to a different parking spot. As shown in FIG. 7, the central processor can control a display 210 that shows the location of the closest available parking space. In this embodiment, the processor is programmed to generate a location of the available parking space based on data received through the mesh network.

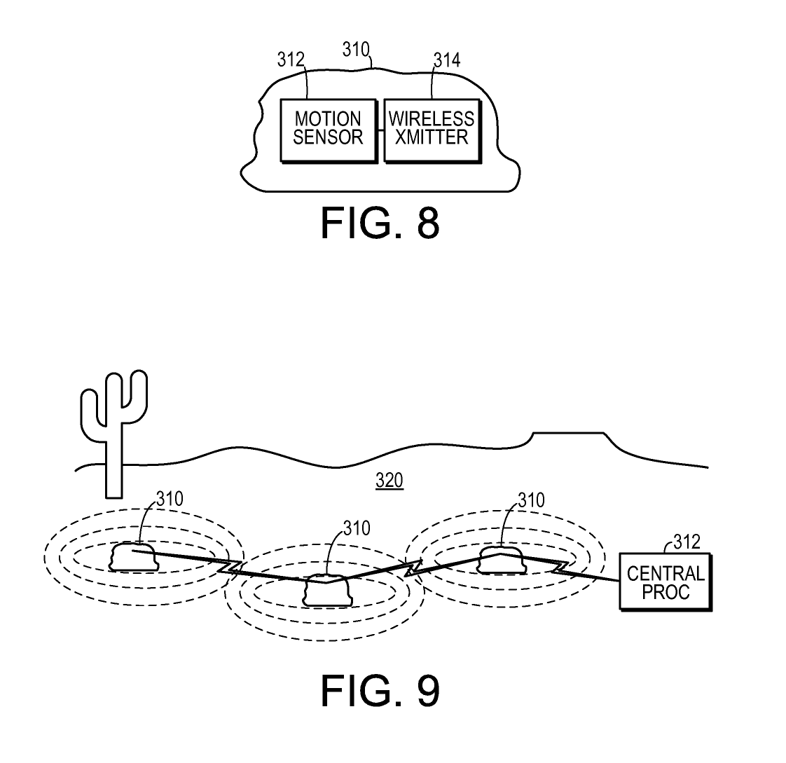

In another embodiment, as shown in FIG. 8, the sensor device (which could include a motion detector or a sensor for a specific type of material) can be concealed in an artificial rock 310 and can include a motion sensor 312 in communication with a wireless transmitter 314. As shown in FIG. 9, several such sensor devices 310 and a central processor 312 can be deployed in an area 320 for perimeter security. For example, it could be used in military applications and border security applications.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A sensor system for detecting a vehicle on a driving surface, comprising:
(a) a sealed casing having a top surface and defining a cavity therein;
(b) an integrated circuit vehicle detector disposed within the cavity and configured to generate a vehicle present electrical signal when the vehicle is within a predetermined distance from the sensor system;
(c) an integrated circuit transmitter and controller disposed within the cavity and in communication with the integrated circuit vehicle detector, the integrated circuit transmitter and controller configured to generate a vehicle present radio frequency signal in response to the vehicle present electrical signal; and
(d) a battery disposed within the cavity and electrically coupled to the integrated circuit vehicle detector and the integrated circuit transmitter and controller.

2. The sensor system of claim 1, further comprising:
(a) a magnet; and
(b) a reed switch disposed adjacent a top portion of the sealed casing inside the cavity and configured to couple selectively the battery to the integrated circuit vehicle detector and the integrated circuit transmitter and controller, the reed switch responsive to the magnet so that the reed switch is held open and the sensor is maintained in an inactive state when the magnet is disposed on the top surface of the sealed casing and so that the reed switch is closed and the sensor system is activated when the magnet is removed from the top surface of the casing.

3. The sensor system of claim 1, wherein the integrated circuit transmitter and controller comprises a mesh network transceiver.

4. The sensor system of claim 1, wherein the sealed casing comprises a vulcanized rubber cylinder having a circular vulcanized rubber bottom floor sealed about a periphery to an interior portion of the rubber cylinder and a vulcanized rubber top cover sealed to a top edge of the rubber cylinder.

5. The sensor system of claim 1, wherein the casing has a top portion having a shape of a road reflector.

6. The sensor system of claim 1, wherein the integrated circuit vehicle detector comprises a magnetic anomaly detector.

7. The sensor system of claim 1, wherein the casing is disposed above a pavement surface and is held thereto with an adhesive.

8. The sensor system of claim 1, wherein the casing comprises a surface mounted road reflector.

9. A vehicle sensor system for detecting a vehicle on a driving surface, comprising:
(a) a sealed casing having a top surface and defining a cavity therein, the sealed casing including a vulcanized rubber cylinder having a circular vulcanized rubber bottom floor sealed about a periphery to an interior portion of the rubber cylinder and a vulcanized rubber top cover sealed to a top edge of the rubber cylinder;
(b) an integrated circuit vehicle detector disposed within the cavity and configured to generate a vehicle present electrical signal when the vehicle is within a predetermined distance from the sensor system;
(c) an integrated circuit transmitter and controller disposed within the cavity and in communication with the integrated circuit vehicle detector, the integrated circuit transmitter and controller configured to generate a vehicle present radio frequency signal in response to the vehicle present electrical signal;
(d) a battery disposed within the cavity and electrically coupled to the integrated circuit vehicle detector and the integrated circuit transmitter and controller; and
(e) a magnetically sensitive reed switch disposed adjacent a top portion of the sealed casing inside the cavity and configured to couple selectively the battery to the integrated circuit vehicle detector and the integrated circuit transmitter and controller, the reed switch responsive to a magnet so that the reed switch is held open and the sensor is maintained in an inactive state when the magnet is disposed on the top surface of the sealed casing and so that the reed switch is closed and the sensor system is activated when the magnet is removed from the top surface of the casing.

10. A parking garage gate system, comprising:
(a) a sensor system configured to detect a vehicle on a driving surface that includes:
(i) a sealed casing having a top surface and defining a cavity therein;
(ii) an integrated circuit vehicle detector disposed within the cavity and configured to generate a vehicle present electrical signal when the vehicle is within a predetermined distance from the sensor system;
(iii) an integrated circuit transmitter and controller disposed within the cavity and in communication with the integrated circuit vehicle detector, the integrated circuit transmitter and controller configured to generate a vehicle present radio frequency signal in response to the vehicle present electrical signal; and
(iv) a battery, disposed within the cavity and electrically coupled to the integrated circuit vehicle detector and the integrated circuit transmitter and controller;
(b) a vehicle passage control gate;
(c) a gate control unit that includes a wireless receiver that is responsive to the vehicle present radio frequency signal and that is configured to cause the vehicle passage control gate to enter a preselected state in response to the vehicle present radio frequency signal.

11. The parking garage gate system of claim 10, further comprising:
(a) a magnet; and
(b) a reed switch disposed adjacent a top portion of the sealed casing and configured to couple selectively the battery to the integrated circuit vehicle detector and the integrated circuit transmitter and controller, the reed switch responsive to the magnet so that the reed switch is held open and the sensor maintained in an inactive state when the magnet is disposed on the top surface of the sealed casing and so that the reed switch is closed and the sensor system is activated when the magnet is removed from the top surface of the casing.

12. The parking garage gate system of claim 10, wherein the integrated circuit transmitter and controller comprises a mesh network transceiver.

13. The parking garage gate system of claim 12, further comprising a plurality of sensor systems, each of which is disposed at a different parking space and each of which is part of a mesh network in communication with the gate control unit.

14. The parking garage gate system of claim 13, further comprising a display unit that displays a location of an available parking space and wherein the processor is further programmed to generate a location of the available parking space based on data received through the mesh network.

15. The parking garage gate system of claim 10, wherein the sealed casing comprises a vulcanized rubber cylinder having a circular vulcanized rubber bottom floor sealed about a periphery to an interior portion of the rubber cylinder and a vulcanized rubber top cover sealed to a top edge of the rubber cylinder.

16. The parking garage gate system of claim 10, wherein the casing has a top portion having a shape of a road reflector.

17. The parking garage gate system of claim 10, wherein the integrated circuit vehicle detector comprises a magnetic anomaly detector.

18. The parking garage gate system of claim 10, wherein at least a portion the casing is mounted in a hole drilled into pavement adjacent to the vehicle passage control gate.

19. The parking garage gate system of claim 10, wherein the casing is disposed above a pavement surface and is held thereto with an adhesive.

20. The parking garage gate system of claim 10, wherein the casing comprises a surface mounted road reflector.
